(19) United States
(12) Patent Application Publication
(10) Pub. No.: US 2006/0280589 A1
(43) Pub. Date: Dec. 14, 2006

(54) Apparatus and method for transferring semiconductor wafers

(76) Inventors: Chang Hwan Choi, Chengju City (KR); Tae Sik Choi, Pyungtaik City (KR); Byung Jo Kim, Chuncheun City (KR)

Correspondence Address: MICHAEL BEST & FRIEDRICH, LLP, 100 E WISCONSIN AVENUE, MILWAUKEE, WI, 53202, US

(21) Appl. No.: 11/343,231

(22) Filed: Jan. 30, 2006

(30) Foreign Application Priority Data
May 27, 2005 (KR) 2005-0044834

(51) Int. Cl. B65G 1/133

(52) U.S. Cl. 414/749.1

(57) ABSTRACT

There is provided apparatus and methods for transferring semiconductor wafers, wherein some embodiments employ a guide body; a first transferring unit including a support reciprocatively slidibly connected to the guide body, and a central finger supported by the support; and a second transferring unit including a base; a driving unit disposed in the support; a ball screw rotated by the driving unit; a guide member connecting with the ball screw, wherein the guide member has an outer inclined surface; a lever in surface contact with the guide member to be rotated around its center by the inclined surface when the guide member moves; a plurality of slide members in contact with the lever and slidable on the guide shaft as the lever rotates; a plurality of connection members spaced from each other and engaging with the corresponding slide members; and driving fingers connected to the corresponding connection members.

### CROSS-REFERENCE TO RELATED APPLICATION

Priority is hereby claimed to Korean Patent Application No. 2005-0044834, filed May 27, 2005, the entire contents of which are incorporated herein by reference.

### BACKGROUND OF THE INVENTION

1. Technical Field

The present invention relates to apparatus and methods for transferring semiconductor wafers, and more particularly, to an apparatus for transferring semiconductor wafers, which has a simplified configuration and structure so that machining and assembling is facilitated, which uses a reduced number of precision parts so that manufacture is simplified and costs are saved, and which is capable of transferring semiconductor wafers at several intervals by selectively adjusting intervals between fingers.

2. Discussion of the Related Art

In a semiconductor fabrication process, heat diffusion or film formation is typically performed in a semiconductor diffusion furnace apparatus. The semiconductor fabrication process is divided into diffusion and deposition according to a film formed by annealing.

Diffusion furnace apparatus may be classified into lateral annealing apparatus and vertical annealing apparatus depending on their form. The vertical annealing apparatus can occupy less space compared to the lateral annealing apparatus when mounted. The vertical annealing apparatus loads or unloads wafers into or out of an annealing furnace without contact with the reaction chamber, thereby achieving a dust-free environment expanding the use of the vertical annealing apparatus.

The vertical annealing apparatus includes a furnace unit for performing annealing, and a utility unit having supply lines for electricity, gas, etc. The furnace unit includes a wafer transferring apparatus for transferring semiconductor wafers, a carrier transferring unit for transferring a carrier on which the semiconductor wafers are loaded, a boat, a chamber in which oxidization and diffusion is performed, a heater, and a control panel. The utility unit includes a power supply, a gas supply chamber, and a pipe unit.

In the thus configured vertical annealing apparatus, when a carrier is loaded into a storing chamber through a wafer carrier inlet/outlet, the carrier transferring unit lifts up the carrier on a stage that can be reached by the wafer transferring apparatus. In other words, the carrier transferring unit transfers the carrier from the carrier inlet/outlet to the storing chamber and from the storing chamber to the stage. The wafer transferring apparatus transfers the wafers between the stage and a quartz boat. In this case, the wafer transferring apparatus begins to transfer the wafers between the carrier on the stage and the quartz boat. When the wafers are loaded on the quartz boat by the wafer transferring apparatus, a shutter blocking heat into an annealing furnace is opened, and a boat elevator operates such that the boat on which the wafers are loaded enters the annealing furnace. The annealing furnace generates heat at approximately 1000° C. to anneal the wafers loaded on the boat and forms a film needed for processes on the wafer. When the process is completed, the wafer and the storing chamber are transferred reversely.

As described above, the vertical annealing apparatus necessarily includes the wafer transferring apparatus for transferring wafers from the carrier, such as a cassette or a front opening unified pod (FOUP), to the boat. When transferring one or five wafers, a conventional wafer transferring apparatus transfers the wafer(s) along a guide road in a horizontal direction using a plurality of stepping motors and a plurality of corresponding transferring units. In order to transfer wafers with carriers having different intervals, the intervals between the wafers can be vertically adjusted by using a vertical ball screw. In the wafer transferring apparatus, however, the wafers can be loaded with a transfer pitch of between about 5 mm and 10 mm on the carrier (e.g., cassette or FOUP), and thus support plates have a thickness as thin as about 4 to 5 mm. This makes it difficult to perform mechanical machining and assembling at a side of each support plate. Further, the transferring method uses a specially fabricated, fine ball screw and a linear guide to adjust the interval between the support plates between 5 and 10 mm. This increases manufacturing time and makes it difficult to perform part assembly and maintenance.

### SUMMARY OF THE INVENTION

Therefore, some embodiments of the present invention provide an apparatus for transferring a semiconductor wafer, which has a simplified configuration and structure so that machining and assembling is facilitated, and which uses a reduced number of precision parts so that manufacture is simplified and costs are saved.

An object of the present invention is to provide an apparatus capable of transferring semiconductor wafers at several intervals by selectively adjusting intervals between fingers.

According to some embodiments of the present invention, the apparatus can be easily machined and assembled because of its simplified configuration and structure, and manufacturing processes can be simplified and costs can be saved by using a reduced number of precision parts.

It is also possible to transfer wafers at several intervals by adjusting intervals between fingers through a cam adjustment.

In accordance with an exemplary embodiment, the present invention provides an apparatus for transferring semiconductor wafers, wherein the apparatus comprises: a guide body; a first transferring unit including a support reciprocatively slidibly connected to the guide body, and a central finger supported by the support; and a second transferring unit, the second transferring unit including: a base disconnectably connecting with the support; a driving unit disposed in the support; a ball screw rotated by the driving unit; a guide member connecting with the ball screw to be movable left and right as the ball screw rotates, the guide member having an outer inclined surface; a lever that is in surface contact with the guide member to be limitedly rotated around its center by the inclined surface when the guide member moves; a plurality of slide members that are in surface contact with the lever and are slid up and down on the guide shaft as the lever rotates; a plurality of connection members spaced from each other at uniform intervals and engaging with the corresponding slide members; and a plurality of driving fingers connected to the corresponding connection members, spaced from each other at uniform intervals, and disposed over and under the central finger.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a rear view of an apparatus for transferring a semiconductor wafer according to an embodiment of the present invention;

FIG. 2 is a plan view of an apparatus for transferring a semiconductor wafer according to an embodiment of the present invention;

FIG. 3 is a side view of an apparatus for transferring a semiconductor wafer according to an embodiment of the present invention; and

FIG. 4 is a front view an apparatus for transferring a semiconductor wafer according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in different forms, and should not be construed as limited to the embodiments set forth herein. Rather, these embodiments are provided so that this disclosure will be thorough and complete, and will more fully convey the scope of the invention to those skilled in the art. In the drawings, the thickness of layers and regions are exaggerated for clarity.

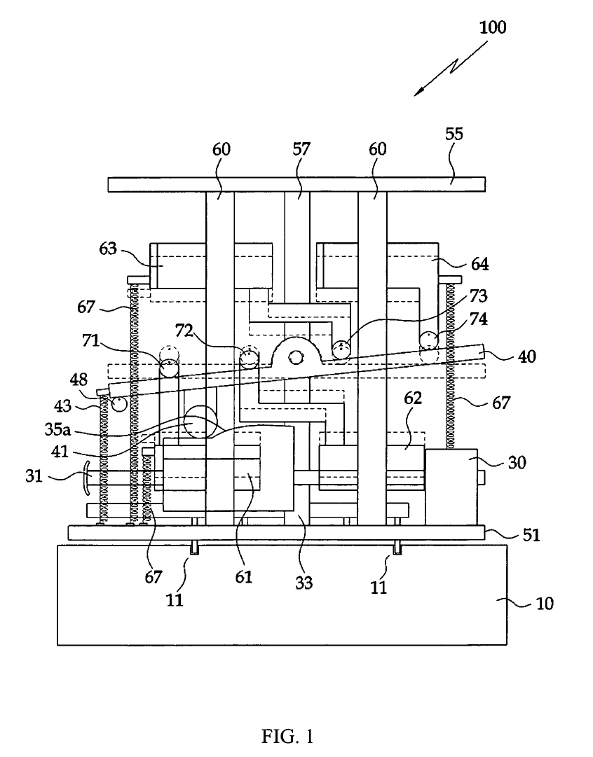

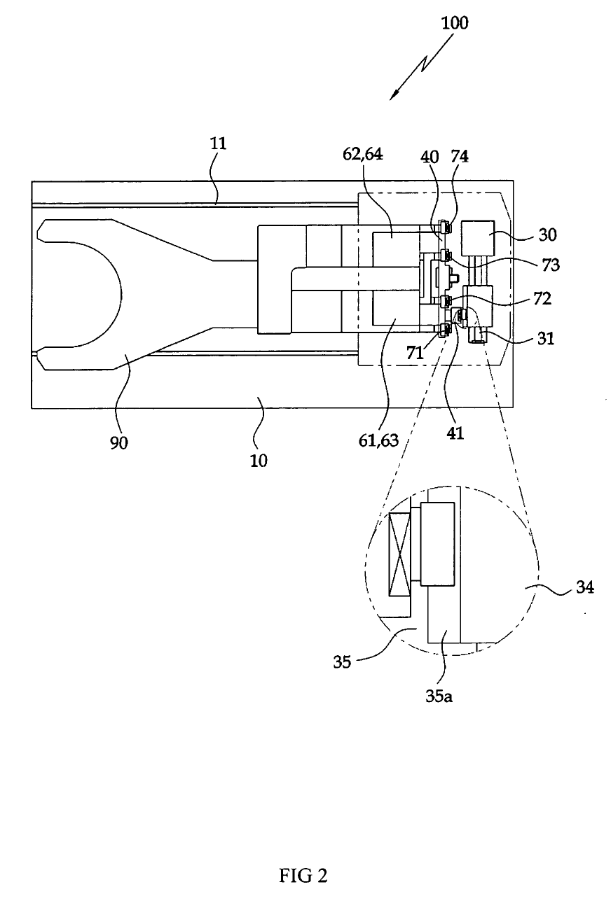

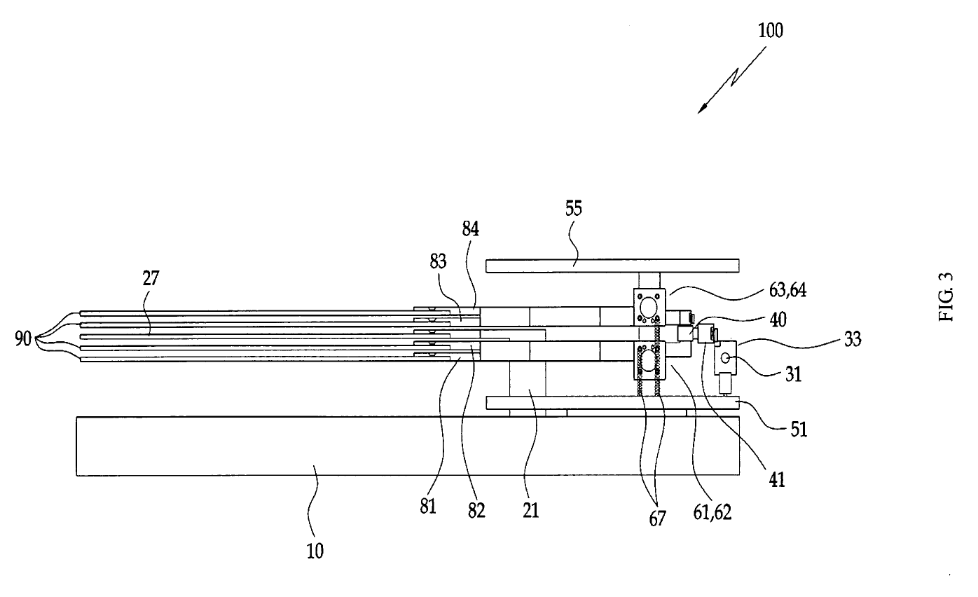

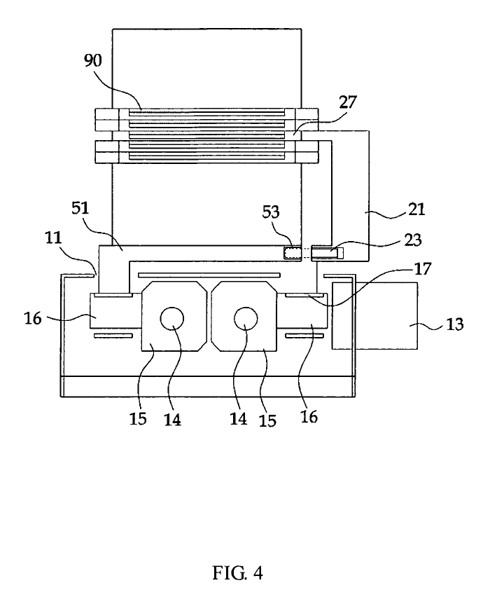

FIG. 1 is a rear view of an apparatus for transferring a semiconductor wafer according to an embodiment of the present invention, FIG. 2 is a plan view of an apparatus for transferring a semiconductor wafer according to an embodiment of the present invention, FIG. 3 is a side view of an apparatus for transferring a semiconductor wafer according to an embodiment of the present invention, and FIG. 4 is a front view an apparatus for transferring a semiconductor wafer according to an embodiment of the present invention. Referring to FIGS. 1 to 4, a semiconductor wafer transferring apparatus 100 according to an embodiment of the present invention includes a guide body 10, and first and second transferring units.

The guide body 10 is in a substantially rectangular parallelepiped shape and has guide grooves 11 at both sides of its longitudinal center.

The first transferring unit includes a support 21 reciprocatively and slidably connected to the guide body 10 and a central finger 27 supported by the support 21. Here, the support 21 is guided by the guide grooves 11 of the guide body 10 and is reciprocatively slid.

The operation of the support 21 inside the guide body 10 will be now described. A driving motor 13 and a plurality of longitudinal shafts 14 are disposed in parallel inside the guide body 10. Further, corresponding transferring blocks 15 are connected to the shafts 14 to slidibly reciprocate on the shaft 14, respectively. Outwardly extending protrusions 16 are formed on the transferring blocks 15, respectively. Here, one of the transferring blocks 15 is connected to the driving motor 13 in order to deliver motive power. This is possible when the driving motor 13 rotates a pulley (not shown) and a timing belt 17 engages with the pulley. The protrusion 16 connects with the support 21 via the timing belt 17. The support 21 can reciprocate as the driving motor 13 rotates.

Meanwhile, the second transferring unit includes a base 51, a ball screw 31, a guide member 33, a lever 40, slide members 61, 62, 63 and 64, and driving fingers 90.

The base 51 reciprocatively and slidably connects with the guide body 10. This is possible when the base 51 connects with one of the transferring blocks 15 that does not connect to the support 21. Further, the base 51 disconnectably connects with the support 21. This is intended to selectively allow only the first transferring unit or both the first transferring unit and the second transferring unit to slide on the guide body 10. In this embodiment, for example, a cylinder 23 is disposed in the support 21, and a groove 53 corresponding to an expansion portion of the cylinder 23 is formed in the base 51. Thus, as the cylinder 23 operates, the first transferring unit can be selectively connected to or disconnected from the second transferring unit.

The ball screw 31 is in a round screw shape, and is rotated by a driving unit disposed in the base 51. Here, the driving unit may be a typical electric motor 30. Of course, the motor 30 should be able to be controlled by an external electrical signal.

The guide member 33 moves left and right in a horizontal direction as the ball screw 31 rotates. To realize this, an inner face of the guide member 33 is contiguous to the outer face of the ball screw 31. An inclined surface 35a is formed on the guide member 33 to drive the lever 40, which will be described below. Here, the guide member 33 may be formed as one body. However, in view of the necessity of a different form of the inclined surface 35a according to movement of the lever 40, the guide member 33 is preferably configured as a combination of a first block 34 connecting with the ball screw 31 to be movable left and right as the ball screw 31 rotates, and a second block 35 having the inclined surface 35a and disconnectably connecting with the first block 34. That is, the inclined surface 35a of the guide member 33 may be selectively modified according to the combined second block 35.

The lever 40 has a center fixed to a shaft 57 that crosses between the base 51 and an opposite upper base 55. The lever 40 is in surface contact with the guide member 33 so that the lever 40 has limited rotation around its center by the inclined surface 35a when the guide member 33 moves. An eccentric cam 41 selectively rotatably connects with the lever 40. Via the cam 41, the lever 40 is in surface contact with the guide member 33. Accordingly, the cam 41 may be adjusted to set a width or spacing by which the lever 40 moves according to the guide member 33. It will be appreciated that the cam 41 should firmly engage with the lever 40 and not move when the cam 41 is adjusted by a preferred value. A stopper cam 48 is provided under one end of the lever 40 to limit movement of the lever 40. The stopper cam 48 is adjustably eccentric, as well. The lever 40 should have a restoration force so that it is restored to an initial state after moving according to the guide member 33. To achieve this, the lever 40 preferably connects with the base 51 via a spring 43 as an elastic unit. While in this embodiment, the lever 40 connects with the base 51 via the spring 43, it will be appreciated that the lever 40 may connect with the upper base 55 via the spring 43. Preferably, the lever 40 is inclined at an initial state, but is kept horizontally when moving according to the guide member 33.

The slide members 61, 62, 63 and 64 are in surface contact with the lever 40 so that they can be slid up and down as the lever 40 moves. At this time, the slide members 61, 62, 63 and 64 are slid on guide shafts 60 that are oppositely disposed at both sides of the shaft 57. Here, the number of the slide members 61, 62, 63 and 64 corresponds to the number of driving fingers 90 that will be described below. In this embodiment, for example, a total of four slide members 61, 62, 63 and 64 are provided with a different height difference on the guide shafts 60. It will be appreciated that the present invention is not limited to such a structure. Preferably, eccentric cams 71, 72, 73 and 74 selectively and rotatably engage with the slides 61, 62, 63 and 64 so that the slide members 61, 62, 63 and 64 are in surface contact with the lever 40 via the cams 71, 72, 73 and 74. The cams 71, 72, 73 and 74 may be selectively adjusted so that intervals between connection members 81, 82, 83 and 84 and intervals between the driving fingers 90 are adjusted by a preferred value. The slide members 61, 62, 63 and 64 have a restoration force so that they are restored to an initial state after moving. Preferably, the slide members 61, 62, 63 and 64 connect with the base 51 via springs 67 as elastic units.

A plurality of connection members 81, 82, 83 and 84 spaced from each other at uniform intervals connect with the corresponding slide members 61, 62, 63 and 64. Preferably, the connection members 81, 82, 83 and 84 are in a zigzag shape or a bent shape to prevent interference therebetween or interference with the support 21.

A plurality of driving fingers 90 connect with the corresponding connection members 81, 82, 83 and 84, and are disposed at both upper and lower sides of the central finger 27.

Operation of the semiconductor wafer transferring apparatus having the structure as described above according to an embodiment of the present invention will be now described.

It is to be noted that, for clarify and convenience of illustration, the slide members, the connection members, and the cams will be described as the first, second, fourth, and fifth slide members 61, 62, 63 and 64, the first, second, fourth, and fifth connection members 81, 82, 83 and 84, and the first, second, fourth, and fifth cams 71, 72, 73 and 74 in FIG. 3.

First, as the motor 30 rotates according to an external signal, the ball screw 31 accordingly rotates. Accordingly, the guide member 33 engaging with the ball screw 31 moves in a horizontal direction, and the inclined surface 35a of the guide member 33 is in close contact with the cam 41 engaging with the lever 40. This moves the lever 40 up from an initial state.

Hence, the cams at the left from the center of the lever 40 in FIG. 1, i.e., the first and second cams 71 and 72 are lifted up so that the first and second slide members 61 and 62 move up. On the other hand, the cams at the right from the center of the lever 40, i.e., the fourth and fifth cams 73 and 74, move down as the lever 40 moves so that the fourth and fifth slide members 63 and 64 connecting with the cams 73 and 74 move down. As the slide members 61, 62, 63 and 64 move in this manner, the first and second connection members 81 and 82 move up and the fourth and fifth connection members 83 and 84 move down. Accordingly, the upper driving finger 90 moves down from the central finger 27 and the lower driving finger 90 moves up, which adjusts the interval between the fingers 27 and 90.

The interval between the fingers 27 and 90 may be adjusted to a preferred value, e.g., between 5 mm and 10 mm by rotating the cams 71, 72, 73 and 74 that engage with the slide members 61, 62, 63 and 64.

According to a preferred embodiment of the present invention, the cylinder 23 enables the first transferring unit to be connected to or disconnected from the second transferring unit. Thus, it is possible to move only the central finger 27 or both a driving finger 90 and the central finger 27.

It is also possible to move one or five wafers loaded on the fingers 27 and 90.

While the present invention has been particularly shown and described with reference to exemplary embodiments thereof, it will be understood by those of ordinary skill in the art that various changes in form and details may be made therein without departing from the spirit and scope of the present invention as set forth in the following claims.

What is claimed is:

1. An apparatus for transferring semiconductor wafers, the apparatus comprising:
a guide body;
a first transferring unit comprising a support reciprocatably and slidably connected to the guide body, and a central finger supported by the support; and
a second transferring unit comprising:
a base disconnectably connected to the support;
a driving unit disposed in the support;
a ball screw rotated by the driving unit;
a guide member connecting with the ball screw to be laterally movable as the ball screw rotates, the guide member having an outer inclined surface;
a lever in surface contact with the guide member to be rotated around a center of the lever by the inclined surface when the guide member moves;
a plurality of slide members and in surface contact with the lever and slidable up and down on a guide shaft as the lever rotates;
a plurality of connection members spaced from each other at uniform intervals and engaging with the corresponding slide members; and
a plurality of driving fingers connected to the connection members, spaced from each other at uniform intervals, and disposed over and under the central finger.

2. The apparatus according to claim 1, wherein a cylinder is disposed in the support, a groove corresponding to an expansion portion of the cylinder is formed in the base, and the first transferring unit is selectively connected to and disconnected from the second transferring unit as the cylinder operates.

3. The apparatus according to claim 1, wherein eccentric cams selectively and rotatably engage with the slide members, and the slide members are in surface contact with the lever via the cams.

4. The apparatus according to claim 1, wherein an eccentric cam selectively and rotatably engages with the lever, and the lever is in surface contact with the guide member via the cam.

5. The apparatus according to claim 1, wherein the second transferring unit further comprises elastic units for connecting between the base and the lever and between the base and the slide members to provide a restoration force to the lever and the slide members.

6. The apparatus according to claim 5, wherein the elastic units are springs.

7. The apparatus according to claim 1, wherein the guide member comprises:
a first block engaged with and laterally movable by the ball screw as the ball screw rotates; and
a second block having the outer inclined surface and disconnectably connected to the first block.

8. The apparatus according to claim 2, wherein the guide member comprises:
a first block engaged with and laterally movable by the ball screw as the ball screw rotates; and
a second block having the outer inclined surface and disconnectably connected to the first block.

9. The apparatus according to claim 3, wherein the guide member comprises:
a first block engaged with and laterally movable by the ball screw as the ball screw rotates; and
a second block having the outer inclined surface and disconnectably connected to the first block.

10. The apparatus according to claim 4, wherein the guide member comprises:
a first block engaged with and laterally movable by the ball screw as the ball screw rotates; and
a second block having the outer inclined surface and disconnectably connected to the first block.

11. The apparatus according to claim 5, wherein the guide member comprises:
a first block engaged with and laterally movable by the ball screw as the ball screw rotates; and
a second block having the outer inclined surface and disconnectably connected to the first block.

12. The apparatus according to claim 6, wherein the guide member comprises:
a first block engaged with and laterally movable by the ball screw as the ball screw rotates; and
a second block having the outer inclined surface and disconnectably connected to the first block.
